(19) United States
(12) Patent Application Publication
(10) Pub. No.: US 2026/0276422 A1
(43) Pub. Date: Sep. 17, 2026

(54) CORIOLIS FLOW-MEASURING DEVICE AND METHOD FOR CALIBRATING AND/OR OPERATING A CORIOLIS FLOW-MEASURING DEVICE

(71) Applicant: Endress+Hauser Flowtec AG, Reinach (CH)

(72) Inventor: Michael Kirst, Lörrach (DE)

(21) Appl. No.: 19/168,571

(22) PCT Filed: Mar. 21, 2024
(86) PCT No.: PCT/EP2024/057608

§ 371 Date: Sep. 24, 2025

(30) Foreign Application Priority Data
Mar. 31, 2023 (DE) 10 2023 108 372.4

(51) Int. Cl. G01F 1/84; G01F 25/10

(52) U.S. Cl. CPC G01F 1/8418; G01F 1/8436; G01F 25/10

(57) ABSTRACT

A Coriolis flow-measuring device includes: a measurement line with a measuring tube for carrying a measuring medium; a calibration line separate from the measurement line for carrying a calibration medium having a calibration tube; an exciter for exciting oscillations of the measurement and calibration lines; a sensor for detecting the oscillations, wherein the exciter and the sensor are each connected to the measurement and to calibration lines in a detachable manner; and measuring-calibration electronics electrically connected to the exciter and the sensor and configured to cause the measuring tube and the calibration tube to oscillate, to determine their oscillations, to determine a calibration variable of the device based on the oscillations of the measurement and calibration lines carrying the calibration medium, and to determine the mass flow, the medium density, and/or the medium viscosity of the measuring medium as a function of the calibration variable and/or a variable derived therefrom.

The invention relates to a Coriolis flow-measuring device for determining a mass flow, a medium density and/or a medium viscosity of a fluid measuring medium, in particular a liquid, in a process line and to a method for calibrating and/or operating a Coriolis flow-measuring device, in particular the Coriolis flow-measuring device according to the invention.

WO 2021/021116 A1 discloses a Coriolis flow-measuring device with a measurement system comprising a measurement line and a measuring tube that are no longer detachable from the measurement line, and a compensation system. The compensation system comprises a compensation tube for carrying a compensation medium. Using measuring device electronics, a mass of the compensation system can be set by introducing the compensation medium into the compensation tube in such a way that it corresponds to the mass of the measurement system or deliberately deviates therefrom. The basic idea is to extend the density range of the measuring medium-the limits of which are limited and fixed by the constant mass of the conventionally used compensating body-by making the mass of the compensating body variable.

WO 99/51946 A1 discloses a clamp-on Coriolis flow-measuring device that is reconnected or can be reconnected in a detachable manner to the outer shell surface of existing process lines. EP 1 150 104 A2 discloses a clamp-on Coriolis flow-measuring device with a housing that can be attached to a process line and in which a carrier plate with an oscillation generator and measuring sensor are arranged. The housing is arranged on the process line in such a way that the process line can be made to perform oscillations mechanically by the oscillation generator during operation, and oscillation of the process line can be detected by the measuring sensor.

From WO 2019/017891 A1 or WO 2021/121867A2 , along with the German patent applications DE 102021105397A1 , DE 102020133614A1 , DE 102020132685A1 , DE 102020133851A1 , DE 102020133566A1 , DE 102020132986A1 , DE 102020132686A1 , DE 102020132685A1 , DE 102020131452A1 , DE 102020132223A1 , DE 102020127356A1 , DE 102020114519A1 , and DE 102020112154A1 , in each case (modular) vibronic measurement systems are known, namely formed namely by means of a carrier system, a tube module mechanically connected to the carrier system along with measurement system electronics electrically connected to the carrier system, and serving to detect at least one measurement variable of a fluid measured substance flowing in a (measurement substance) line, namely to determine measurement values for one or more measured variables, for example, a mass flow, a volume flow, a density and/or a viscosity, of the measurement substance.

The carrier system of such a (modular) vibronic measurement system has a (protective) housing with at least one chamber at least partially encased by a housing wall and one or more electrical coils, for example, cylindrical and/or designed as air coils, which are placed (at a distance from each other) inside the chamber of the (protective) housing and are at least indirectly mechanically connected to the housing wall. Each of the coils is also electrically connected to the measurement system electronics. The measurement system electronics can be housed at least partially inside the (protective) housing and/or at least partially outside the (protective) housing—for example, namely in a separate electronics housing. In particular, the carrier system is also configured to receive the tube module of the measurement system and to be connected thereto in a mechanically fixed (forming a vibration-type transducer), yet detachable manner, in particular namely to form the vibronic measurement system itself; this is also done in particular in such a manner that the tube module is locked in the carrier system or cannot be moved.

The tube module of the corresponding measurement system is also designed to be replaceable, in such a manner that it can be inserted into the chamber, in particular also on site, from outside the (protective) housing of the carrier system or through an (insertion) opening of the housing provided in the housing wall, and that it can be removed from the carrier system again in a non-destructive manner, possibly also without tools, in particular namely from outside the housing, and/or can be removed through the (insertion) opening of the housing or without the carrier system itself having to be handled or removed from the (process) plant. This also makes it possible, among other things, to insert a tube module subsequently on site, namely into an already installed carrier system, or to replace a defective or worn tube module on site with an intact new tube module, which may only be used once or only for a predetermined period of time (“disposable”). The tube module furthermore in each case has one or more, for example, cylindrical, permanent magnets and is furthermore configured to be installed in the carrier system in such a manner that each of the permanent magnets is placed within the aforementioned chamber, but in each case is nevertheless at a distance from the housing wall, in particular in such a manner that each of the permanent magnets is held in a static installation position predetermined in each case with respect to an alignment and/or a smallest distance from one of the electrical coils of the carrier system, and that a corresponding imaginary longitudinal axis of each of the permanent magnets and an imaginary longitudinal axis of at least one of the electrical coils are aligned with each other or run parallel to each other in extension.

In the measurement systems in question, each tube module further has at least one (measuring tube, for example, straight, at least in portions and/or curved at least in portions, with a tube wall forming an outer shell surface of the tube, in particular made of a metal or a plastics material, and with a lumen encased by the same tube wall, in particular namely two substantially identical parallel (measuring tubes, and each of the aforementioned permanent magnets is fixed to the outside of the tube wall, in particular namely to a central segment of the tube wall extending between a first segment end and a second segment end remote therefrom, in particular namely is connected to the tube wall by means of a material bond. In addition, the tube module or its at least one (measuring tube is designed to be installed in the housing, if necessary without tools, in such a manner that the tube is placed at least partially, in particular completely, within the chamber, but is nevertheless spaced apart from the housing wall, and that each of the permanent magnets in the corresponding installation position together with the corresponding electrical coil form a voice coil, in particular serving as an electrodynamic oscillation exciter, and/or a plunger coil, in particular serving as an electrodynamic oscillation sensor. In the case of a (measuring tube that is bent at least in portions, the aforementioned central segment can, for example, be substantially U-shaped or V-shaped. In such a vibronic measurement system, each of the above-mentioned (measuring tubes is also in each case configured to carry a fluid measurement substance flowing within the lumen during operation, in particular with a predeterminable flow direction and/or flow direction pointing from the first segment end to the second segment end, and to be vibrated in the meantime in order to generate measuring effects correlated with one or more measurement variables of the measurement substance, in particular in such a manner that the central segment performs oscillating movements about a static rest position and/or that the (measuring tube is driven by means of at least one of the aforementioned (energized) voice coils and/or that in each case an (alternating) voltage representing oscillating movements of the at least one tube and thus serving as an oscillation signal is generated by means of the aforementioned plunger coils. The measurement system electronics of such a measurement system are in turn configured accordingly, by means of an electrical driver signal, in particular with an impressed alternating current and/or an impressed (alternating current) frequency substantially corresponding to a resonance frequency of the at least one tube, to feed electrical power into the at least one electrical coil forming the aforementioned voice coil and/or by means of the (alternating) voltage generated by the at least one electrical coil forming the aforementioned plunger coil, to determine measurement values for the one or more measurement variables to be detected for the measurement substance flowing through the (measuring) tube or tubes, in the case of a measuring device designed as a Coriolis mass flow meter or measuring device designed as a Coriolis mass flow/density measuring device, for example, namely to generate (mass flow) measurement values representing the mass flow on the basis of a (measured) phase difference, caused by Coriolis forces in the measurement substance flowing through the oscillating tube, between two of the aforementioned oscillation signals and a phase difference to measurement value characteristic curve function configured in the measurement system electronics. The phase difference to mass flow measurement value characteristic curve function can, for example, be a (linear) parameter function with a (scale) zero point that corresponds to a (measured) phase difference of the two oscillation signals that can be measured when the measurement substance is at rest or when the mass flow is zero, and with a slope which corresponds to a (measuring) sensitivity of the measurement system or a change in the (measured) phase difference related to a change in the mass flow. Since one or more resonance frequencies of the at least one tube are particularly also dependent upon the instantaneous density of the corresponding medium, by means of such a measurement system, in addition to the mass flow, the density of the corresponding measurement substance in each case flowing through it can also be measured directly by means of the (alternating current) frequency of the driver signal and/or by means of a (signal) frequency of at least one of the oscillation signals. Accordingly, the measurement system electronics of measurement systems of the type in question are typically further equipped to generate (density) measurement values representing the density on the basis of the aforementioned (alternating) current frequency of the driver signal and/or on the basis of a corresponding signal frequency of at least one of the oscillation signals, for example, using a useful frequency to measurement value characteristic curve function configured accordingly in the measurement system electronics. Furthermore, it is also possible to directly measure the viscosity of the medium flowing through by means of vibronic measurement systems of the type in question, for example, based upon an exciter energy or excitation power required to maintain the useful oscillations and/or based upon a damping of the excited (resonance) oscillations resulting from a dissipation of oscillation energy or by using a damping-to-measurement value characteristic curve function configured accordingly in the measurement system electronics. In addition, further measurement variables derived from the aforementioned flow and/or substance parameters, such as the Reynolds number, can be easily determined by means of such vibronic measurement systems.

To simplify the commissioning of a measurement system formed in this manner, the tube module may further have at least one identifying element relating to or carrying identifying information about the tube module, for example, a barcode, QR code, or RFID label attached to at least one tube and/or the carrier system can have at least one light-emitting semiconductor element positioned inside the (protective) housing and connected to the measurement system electronics, for example, a light-emitting diode (LED), and/or one or more radio transmitters/receivers (RF transceivers) and/or photosensors, for example, namely one or more CCD photosensors and/or one or more CMOS photosensors, in each case positioned inside the (protective) housing and connected to the measurement system electronics.

Vibronic measurement systems of the type in question must also be regularly checked for their functional efficiency or any deviations from a corresponding reference state determined in advance, for example, namely in the state determined by the manufacturer or in the manufacturer's factory and/or during a calibration or commissioning of the corresponding measurement system on site, for example, in order to be able to detect as early as possible any reductions in the functionality or measuring accuracy of the measurement system associated with increased deviations from the reference state, with which the measurement system ultimately maps the measurement variable to be detected, not least the mass flow and density, into the corresponding measurement values. Such reductions in the functional efficiency or measuring accuracy of such a measurement system can occur, for example, in the form of mostly irreversible changes in the electrical impedance of the aforementioned swing and/or plunger coils and/or a permanently reduced stability of the mechanical connection between the base and the tube module or the precision of the positioning of the tube module in the carrier system, or can be caused, for example, by thermal and/or mechanical overloads, approximately as a result of very high or very low temperatures within the carrier system, aging, increased or condensing moisture within the carrier system, and/or wear of components of the carrier system caused by frequent replacement of tube modules. Other influencing factors that at least indirectly and/or at least temporarily impair the functional efficiency of the measurement system include multi-frequency and/or high-frequency electromagnetic (external) radiation or fields (EMC) propagating within the carrier system or (external) sound waves propagating within the carrier system, for example, in the form of structure-borne sound.

As a result, it must regularly be assumed that one or more of the system functions (transfer functions) in each case inherent in the measurement system, each of which characterizes a functional dependence of the aforementioned oscillation signals upon the corresponding driver signal or one or more functional dependencies of the oscillation signals upon the driver signal and the corresponding flow and/or substance parameters of the measurement substance, is also changed in comparison to a (reference) system function inherent in the corresponding original transducer. Examples of such system functions of the measurement system include a mass flow to phase difference system function, in accordance with which the aforementioned (measured) phase difference of the oscillation signals is dependent upon the mass flow, or a density-to-resonance frequency system function of the transducer, in accordance with which one or more resonance frequencies of the at least one tube are dependent upon the density of the measurement substance. Equally affected by such (over)loading of the transducer are accordingly also the measurement functions of the measurement system involving the aforementioned system functions, in accordance with which the measurement system as a whole converts the corresponding measurement variable to be recorded into the corresponding measurement values, for example, a characteristic curve function composed of the aforementioned mass flow to phase difference system function and a phase difference to mass flow measurement value characteristic curve function, namely, a characteristic curve function implemented in the measurement system electronics, in accordance with which a determined phase difference is converted into mass flow measurement values, mass flow to measurement value measuring function of the measurement system, in accordance with which mass flow measurement values determined thereby are dependent upon the mass flow. The phase difference-to-mass flow measurement value characteristic curve function can, for example, be a (linear) parameter function with a (scale) zero point corresponding to a (measured) phase difference measured when the measurement substance is at rest, and a (measuring) sensitivity corresponding to a change in the (measured) phase difference related to a change in the mass flow (slope of the characteristic curve function). Further examples of such system functions that are also potentially affected by malfunctions or measurement functions formed with them include a density-to-resonance-frequency system function of the transducer or a density-to-measurement value (measurement) function of the measurement system involving this and a resonant-frequency-to-density measurement value characteristic curve function of the measurement system electronics and/or a viscosity-to-damping system function of the transducer or a viscosity-to-measurement value (measuring) function of the measurement system involving this and a damping-to-viscosity-measurement value characteristic curve function of the measurement system electronics. The change in the corresponding system function can accordingly have an effect, for example, as a drift of one or more of the corresponding characteristic curve parameters of one or more of the aforementioned characteristic curve functions, in the case of a linear parameter function, for example, of its zero point and/or its slope. The aforementioned, possibly also irreversible changes to one or more of the system or measurement functions of the measurement system can occasionally also lead to the measurement system as a whole working incorrectly to such an extent that the high measuring accuracy typically aimed for in such measurement systems is no longer ensured, meaning that the functional efficiency of the measurement system is considerably impaired, possibly even suspended, or that there is a correspondingly critical malfunction of the affected measurement system.

To take this into account, measurement systems of the type in question are typically calibrated accordingly at the factory. It goes without saying that a calibration at the factory can never represent the concrete use case on site. It is especially typical for measurement systems of the type in question that the measuring environment—i.e., the measuring medium, the process line and/or parts of the measurement system—can change frequently.

Furthermore, especially in applications that place heavy demands on the measurement system, it may be of interest to perform a (re-)calibration of the Coriolis flow-measuring device without having to remove the entire measurement system or parts of the measurement system from the process line.

Furthermore, when using sterile (disposable) measuring tubes, it is desirable that they do not come into contact with a calibration medium prior to use.

The invention is based on the object of providing a suitable solution for on-site calibrations.

The object is achieved by the Coriolis flow-measuring device according to claim 1 and the method for calibrating and/or operating a Coriolis flow-measuring device according to claim 19.

The Coriolis flow-measuring device according to the invention for determining a mass flow, a medium density and/or a medium viscosity of a fluid measuring medium, in particular a liquid, in a process line, comprises:
a measurement system,
   wherein the measurement system comprises a measurement line for carrying the measuring medium,
   wherein the measurement system has at least one measuring tube, in particular one that is sterile and/or connected in a detachable manner to the measurement line and/or designed as a disposable product,
a calibration system,
   wherein the calibration system has a calibration line separate from the measurement line for carrying a calibration medium, in particular water or glycerol,
   wherein the calibration system comprises at least one calibration tube, in particular one that is non-sterile and/or arranged parallel to the measuring tube,
a (“combination”) exciter system for exciting mechanical oscillations of both the measurement system and the calibration system;
a (“combination”) sensor system for detecting mechanical oscillations of both the measurement system and the calibration system;
wherein the exciter system and the sensor system are in each case connected to the measurement system and to the calibration system, in particular the exciter system and the sensor system are in each case connected to the measurement system and to the calibration system, preferably in a detachable manner;
along with measuring and calibration electronics,
   wherein the measuring and calibration electronics are electrically connected to both the exciter system and the sensor system and are configured to cause both the measuring tube and the calibration tube to oscillate by means of the exciter system and to determine the oscillation by means of the sensor system,
   wherein the measuring and calibration electronics are configured to determine at least one calibration variable of an overall system formed by the measurement system and the calibration system based on oscillations determined by means of the sensor system both of the measurement system, in particular the measurement system carrying the measuring medium, and of the calibration system carrying the calibration medium, in particular if the calibration medium is carried in the calibration system with a predetermined (reference) mass flow and/or a predetermined (reference) density and/or a predetermined (reference) viscosity,
   wherein the measuring and calibration electronics are configured to determine, in particular based on oscillations determined by means of the sensor system, both of the measurement system carrying the measuring medium, in particular through which the measuring medium flows, and of the calibration system, in particular carrying the calibration medium, to determine the mass flow, the medium density and/or the medium viscosity of the measuring medium carried in the measurement system as a function of the at least one calibration variable and/or a variable derived therefrom, in particular if the measuring medium flows in the measurement system.

Advantageous embodiments of the invention are the subject matter of the dependent claims.

One embodiment provides that the exciter system and the sensor system are either in each case connected to the measurement system in a non-detachable manner and detachable again with the calibration system, in each case connected to the calibration system in a non-detachable manner and detachable again with the measurement system, or in each case connected to the calibration system in a detachable manner and detachable again with the measurement system.

One embodiment provides that the measurement system and the calibration system are configured to be flowed through independently of each other by the measuring medium or calibration medium, in particular in such a way that the measuring medium and the calibration medium flow simultaneously with deviating mass flows and/or at different times through the Coriolis flow-measuring device.

One embodiment provides that the calibration system comprises a pump, which is configured to pump the calibration medium through the calibration line with a predetermined or predeterminable mass flow, in particular in such a way that the mass flow of the calibration medium is equal to a mass flow of the measuring medium and/or that the mass flow of the calibration medium corresponds to a target mass flow determined based on oscillations determined by means of the sensor system of both the measurement system carrying the measuring medium and the calibration system carrying the calibration medium.

One embodiment provides that the calibration system has a calibration fastening device with which the calibration tube can be attached to the measuring tube for assembly, in particular radially, and can be connected in a mechanically detachable manner to the measuring tube.

One embodiment provides that the measurement system has a measuring fastening device with which the measuring tube can be attached to the calibration tube for assembly, in particular radially, and can be connected in a mechanically detachable manner to the calibration tube.

In one embodiment, the Coriolis flow-measuring device comprises:
a carrier system,
   wherein the exciter system and the sensor system are connected, in particular in a non-detachable manner, to the carrier system.

One embodiment provides that the measuring tube and the calibration tube are mechanically connected to each other, in particular in a non-detachable manner, and form a tube module,
wherein the tube module can be arranged in a mechanically detachable manner on the carrier system.

One embodiment provides that the carrier system has a carrier fastening device via which the measuring tube and/or the calibration tube can be connected to the carrier system in a mechanically detachable manner.

One embodiment provides that the exciter system comprises a mechanical exciter that is in magnetic interaction with the measuring tube and the calibration tube.

One embodiment provides that the exciter system comprises an electromagnetic exciter, which is in magnetic interaction with a measuring tube magnet and a calibration tube magnet,
wherein the measuring tube magnet is arranged on the measuring tube,
wherein the calibration tube magnet is arranged on the calibration tube.

One embodiment provides that the sensor system comprises at least one electrodynamic, electromagnetic or optical sensor.

One embodiment provides that the measuring tube and the calibration tube are mechanically coupled to each other, in particular by means of mechanical couplers.

One embodiment provides that the calibration medium has a predetermined density, a predetermined temperature and/or a predetermined viscosity.

One embodiment provides that the measuring tube has at least one resonance frequency, which is equal to a resonance frequency of the calibration tube, in particular in such a way that a resonance frequency of a first-order bending oscillation mode inherent in the measuring tube is equal to a resonance frequency of a first-order bending oscillation mode inherent in the calibration tube; and/or
wherein the measuring tube and the calibration tube match with regard to one or more geometric parameters, in particular a (tube) length and/or a (tube) wall thickness and/or a caliber.

One embodiment provides that the tube wall of the measuring tube consists of a metal, in particular stainless steel; and/or
wherein the tube wall of the calibration tube consists of a metal, in particular stainless steel; and/or
wherein the tube wall of the calibration tube consists of the same material as the tube wall of the measuring tube.

One embodiment provides that the measuring tube and calibration tube are identical in construction.

In one embodiment, the measuring tube is part of the measurement line.

One embodiment provides that the calibration tube is a part, in particular an integral one, of the calibration line.

One embodiment provides that the calibration medium is different from the measuring medium.

One embodiment provides that the calibration medium is carried exclusively in the calibration line and does not originate from the measurement line or process line.

The method according to the invention for calibrating and/or operating a Coriolis flow-measuring device, in particular a Coriolis flow-measuring device according to the invention,
wherein the Coriolis flow-measuring device comprises measuring and calibration electronics, a sensor system, an exciter system, a measurement system with a measurement line for conducting a measuring medium and a calibration system with a calibration line separate from the measurement line for conducting a calibration medium,
which method comprises the following steps:
conducting the calibration medium through the calibration line,
performing a calibration if the calibration medium flows through the calibration line at a predetermined mass flow,
wherein the calibration comprises exciting the calibration line and the measurement line to perform oscillations by means of the exciter system,
wherein the calibration comprises measuring the oscillations of the calibration tube and the measuring tube by means of the sensor system,
wherein the calibration comprises determining at least one calibration variable as a function of the measured oscillations for an overall system shown by the measurement system and the calibration system by means of the measuring and calibration electronics;
conducting the measuring medium through the measurement line;
and determining the mass flow, the medium density and/or the medium viscosity of the measuring medium as a function of the determined calibration variable.

One embodiment provides that the measuring tube is free of the measuring medium during calibration.

One embodiment provides that the measuring tube carries a measuring medium, in particular a stationary one, during calibration.

One embodiment provides that the calibration tube is free of the calibration medium during the determination of the mass flow, the medium density and/or the medium viscosity of the measuring medium.

One embodiment provides that the calibration tube carries a calibration medium, in particular a flowing one, during the determination of the mass flow, the medium density and/or the medium viscosity of the measuring medium.

In one embodiment, the method comprises the following:
setting a mass flow of the calibration medium, in particular by means of a pump, in such a way that the mass flow of the calibration medium corresponds to a predetermined target mass flow and/or is equal to a mass flow of the measuring medium (carried in the measurement line); and/or
using the pump for setting a mass flow of the calibration medium, in particular while the measurement line is carrying measuring medium and/or while no measuring medium is flowing in the measurement line.

One embodiment provides that the measuring medium and the calibration medium match with regard to at least one substance parameter, in particular a density and/or a viscosity, in particular in such a way that the measuring medium is used as the calibration medium or the calibration medium corresponds to the measuring medium.

One embodiment provides that the measuring medium and the calibration medium deviate from each other with regard to at least one substance parameter, in particular a density and/or a viscosity.

One embodiment provides that the calibration medium contains water, in particular namely (distilled) water.

In one embodiment, the calibration medium contains glycerol.

One embodiment provides that the calibration medium contains oil or is an oil.

In one embodiment, the method comprises the following:
exciting the calibration line and the measurement line to oscillate by means of the exciter system while the measurement line carries the measuring medium, in particular namely while the measuring medium flows through it.

In one embodiment, the method comprises the following:
comparing the determined calibration variable with a default value and/or default range, in particular one provided at the factory.

The invention is explained in greater detail with reference to the following figures, in which:

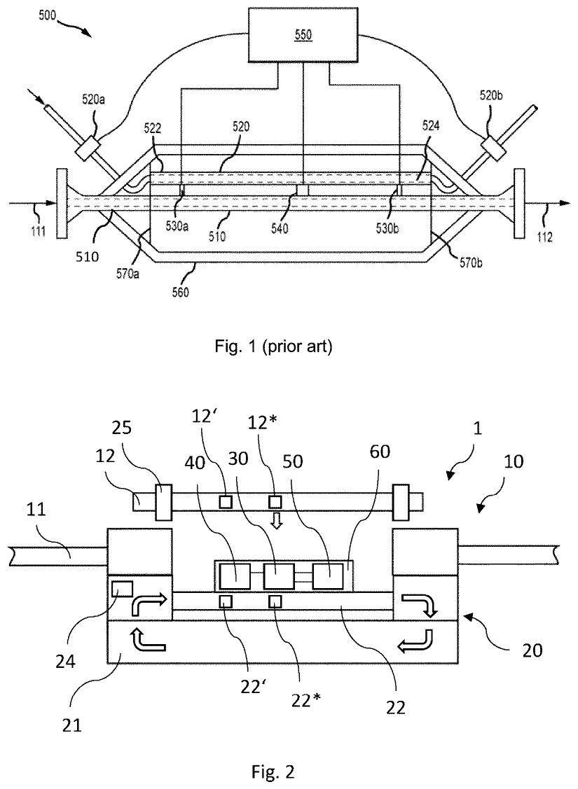

FIG. 1: shows a longitudinal section through a Coriolis flow-measuring device according to the prior art;

FIG. 2: shows a longitudinal section through a first embodiment of the Coriolis flow-measuring device according to the invention;

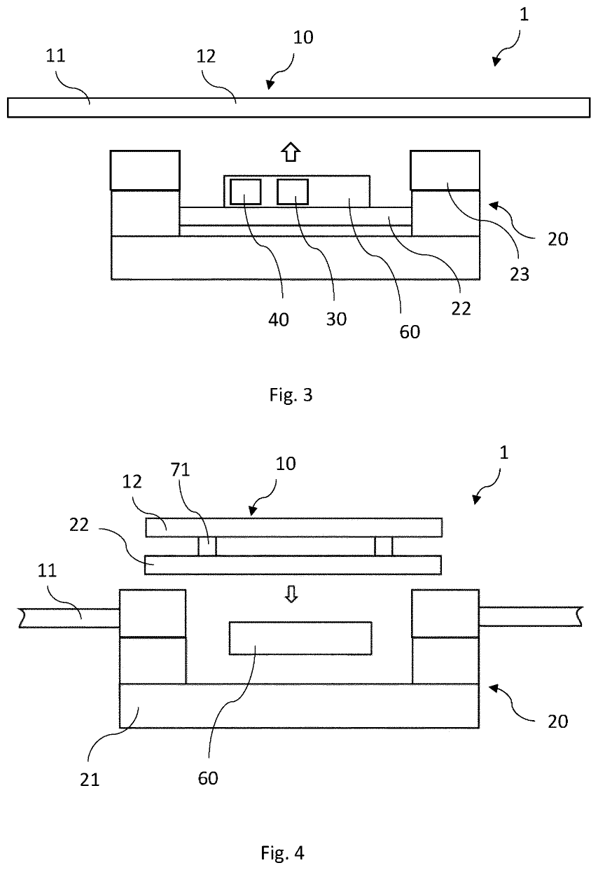

FIG. 3: shows a longitudinal section through a second embodiment of the Coriolis flow-measuring device according to the invention;

FIG. 4: shows a longitudinal section through a third embodiment of the Coriolis flow-measuring device according to the invention;

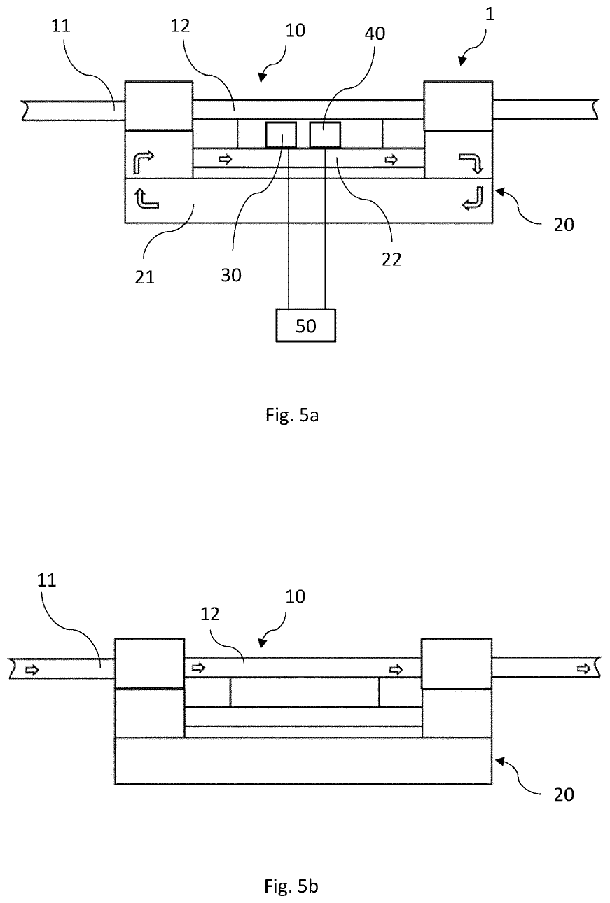

FIG. 5a: shows a representation of a calibration process of the Coriolis flow-measuring device;

FIG. 5b: shows a representation of a measuring process of the Coriolis flow-measuring device; and

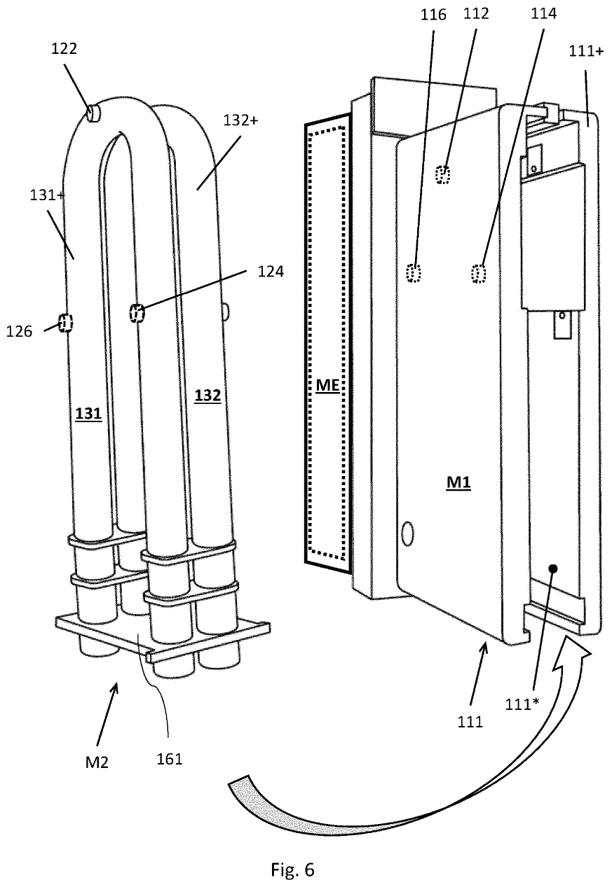

FIG. 6: shows a perspective view of a further embodiment of a Coriolis flow-measuring device according to the invention.

FIG. 1 shows a cross section through a Coriolis flow-measuring device according to the prior art (FIG. 5 from WO 2021/021116 A1). The vibronic flow-measuring device 500 shown comprises a measuring tube 510 for carrying the measuring medium in a flow direction 111, 112. A housing 560 is arranged on the measuring tube 510 for protecting the measuring tube 510 and the components arranged in the housing. The measuring tube 510 is mechanically connected to a compensating rod 520 with a variable mass via a first coupler 570a and a second coupler 570b. The compensating rod 520 has a compensating body 522 that is designed in such a way that a compensating medium 524 can be carried through it or into it. The compensating rod 520, like the measuring tube 510, also extends at least in portions in the housing 560. A left sensor coil 530a, a right sensor coil 530b and a driver 540 positioned between the left and right sensor coils 530a,b are arranged between the measuring tube 510 and the compensating rod 520 and coupled thereto. The left sensor coil 530a, the right sensor coil 530b and the driver 540 are also coupled to a measuring device electronics 550. The measuring device electronics 550 are also electrically connected to an inlet valve 520a and an outlet valve 520b, which are in each case connected to the compensating rod 520 and are configured to let in and out the compensating medium 524. The measuring device electronics 550 are configured to control the inlet and outlet valves 520a,b in order to adjust the mass of the compensating rod 520 via the amount of compensating medium 524 in the compensating body 522. When determining the mass flow of the medium, the mass of the compensating rod is kept constant over time. Unlike the present invention, the compensating rod 520 is not used for (re)calibrating the Coriolis flow-measuring device.

FIG. 2 shows a schematic representation of a first embodiment of the Coriolis flow-measuring device 1 according to the invention for determining a mass flow, a medium density and/or a medium viscosity of a fluid measuring medium, in particular a liquid, in a process line with a measurement system 10, a calibration system 20, a (“combination”) exciter system 30 for exciting mechanical oscillations, a (“combination”) sensor system 40 for detecting mechanical oscillations, measuring and calibration electronics 50, along with a carrier system 60 on which the (“combination”) exciter system 30, the (“combination”) sensor system 40 and the measuring and calibration electronics 50 are arranged.

The measurement system 10 has a measurement line 11 for carrying the measuring medium and a sterile measuring tube 12 that can be connected in a detachable manner to the measurement line 11. The measurement line 11 can comprise at least two process connections for connecting the measuring tube 12 to a process line or a hose system. Alternatively, the measurement line 11 can comprise an adapter that forms a transition between the measuring tube 12 and the process line or hose system. The measuring tube 12 shown is a disposable product that can be replaced every time the measuring medium is changed. The measuring tube 12 can be formed from metal, glass and/or plastics material. Together, the measurement line 11 and the measuring tube 12 form a measuring channel for carrying the measuring medium.

The calibration system 20 has a calibration line 21 separate from the measurement line 11 for carrying a calibration medium, in particular water or glycerol. A calibration tube 22 arranged to run parallel to the measuring tube 12 is designed as an integral part of the calibration line 21 in the embodiment shown. The calibration tube 22 can-unlike the measuring tube 12 shown -also be designed, for example, as non-sterile.

The measuring tube 12 and the calibration tube 22 can match with regard to one or more geometric parameters, in particular a (tube) length and/or a (tube) wall thickness and/or a caliber, for example, they can be namely of identical construction.

The exciter system 30 and the sensor system 40 are in each case connected to the measurement system 10 and to the calibration system 20. In the variant shown, the exciter system 30 and the sensor system 40 are in each case connected in a non-detachable manner to the calibration system 20 and in a detachable manner to the measurement system 10. In addition, the exciter system 30 and the sensor system 40 are connected in a non-detachable manner to the carrier system 60. The exciter system 30 shown can comprise at least one electromagnetic exciter, i.e., an exciter coil, which is in magnetic interaction with a measuring tube magnet 12* and is configured to cause the measuring tube 12 to vibrate. The same electromagnetic exciter or another electromagnetic exciter can be in magnetic effect with a calibration tube magnet 22* and be configured to cause the calibration tube 22 to vibrate. In the embodiment shown, the measuring tube magnet 12* is arranged on the measuring tube 12 and the calibration tube magnet 22* is arranged on the calibration tube 22. Alternatively, the exciter system 30 can comprise an exciter coil arranged on the calibration tube 22 and an exciter magnet attached to the measuring tube 12, which are in each case arranged in such a way that they are in magnetic interaction with each other when the measuring tube 12 is arranged. Alternatively, the exciter system 30 can comprise an exciter coil arranged on the measuring tube 12 and an exciter magnet attached to the calibration tube 12, which are in each case arranged in such a way that they are in magnetic interaction with each other when the measuring tube 12 is arranged. Likewise, the sensor system 40 can comprise one or two sensor coils arranged on the calibration tube 22 or sensor coils attached and one or two sensor magnets arranged on the measuring tube 12 or sensor magnets attached, which are in each case arranged in such a way that they are in magnetic interaction with each other when the measuring tube 12 is arranged on the carrier system 60. In this case, a carrier system 60 would not be necessary.

The sensor system 40 may comprise at least one electrodynamic, electromagnetic or optical sensor. In the embodiment shown, the sensor system 40 has a sensor coil that is in interaction with a measuring tube magnet 12′ and a calibration tube magnet 22′. Alternatively, the sensor system can comprise two sensor coils at a distance from each other that are positioned in or on the carrier system 60 in such a way that the exciter coil is located between them. The measuring tube magnet 12′ is arranged offset in the longitudinal direction of the measuring tube 12 relative to the measuring tube magnet 12* on the measuring tube 12. The calibration tube magnet 22′ is arranged offset in the longitudinal direction of the calibration tube 22 relative to the calibration tube magnet 22* on the calibration tube 22.

The measuring and calibration electronics 50 are electrically connected to both the exciter system 30 and the sensor system 40 and are configured to cause both the measuring tube 12 and the calibration tube 22 to perform oscillations by means of the exciter system 30 and to determine the oscillation by means of the sensor system 40. Furthermore, the measuring and calibration electronics 50 are configured to determine at least one calibration variable of an overall system formed by the measurement system 10 and the calibration system 20 based on oscillations determined by means of the sensor system 40 both of the measurement system 10, in particular the measurement system carrying the measuring medium, and of the calibration system 20 carrying the calibration medium, in particular if the calibration medium is carried in the calibration system 20 with a predetermined (reference) mass flow and/or a predetermined (reference) density and/or a predetermined (reference) viscosity.

In the embodiment shown, the measuring and calibration electronics 50 are arranged on the 32 carrier system 60. Alternatively, it can also be arranged in a separate transmitter housing, detached from the carrier system 60.

Furthermore, the measuring and calibration electronics 50 are configured, in particular based on oscillations determined by means of the sensor system 40, both of the measurement system 10 carrying the measuring medium, in particular through which the measuring medium flows, and of the calibration system 20, in particular carrying the calibration medium, to determine the mass flow, the medium density and/or the medium viscosity of the measuring medium carried in the measurement system 10 as a function of the at least one calibration variable and/or a variable derived therefrom, in particular if the measuring medium flows in the measurement system 10. The measurement system 10 and the calibration system 20 are configured to be flowed through independently of each other by the measuring medium or calibration medium, in particular in such a way that the measuring medium and the calibration medium flow simultaneously with deviating mass flows and/or at different times through the Coriolis flow-measuring device 1.

The calibration system 20 further comprises a pump 24, which is configured to pump the calibration medium through the calibration line 21 with a predetermined or predeterminable mass flow, in particular in such a way that the mass flow of the calibration medium is equal to a mass flow of the measuring medium and/or that the mass flow of the calibration medium corresponds to a target mass flow determined based on oscillations determined by means of the sensor system 40 of both the measurement system 10 carrying the measuring medium and the calibration system 20 carrying the calibration medium.

The measurement system 10 has a measuring fastening device 25 with which the measuring tube 12 can be attached to the calibration tube 22 for assembly, in particular radially, and can be connected in a mechanically detachable manner to the calibration tube 22. Fastening means for forming a positive and/or non-positive connection are suitable as the measuring fastening device 25. Examples of this are disclosed in WO 2019017891A1 , DE 102020114519 A1 and DE 102020127356A1 .

The above statements with respect to the measuring and calibration electronics 50 also refer to the following embodiments.

FIG. 3 shows a schematic representation of a second embodiment of the Coriolis flow-measuring device 1 according to the invention for determining a mass flow, a medium density and/or a medium viscosity of a fluid measuring medium, in particular a liquid, in a conventional process line with a measurement system 10, a calibration system 20, a (“combination”) exciter system 30 for exciting mechanical oscillations, a (“combination”) sensor system 40 for detecting mechanical oscillations, and a carrier system 60. The carrier system 60 can be connected to the calibration tube 22 in a mechanically non-detachable or mechanically detachable manner. In the embodiment shown, the measurement line 11 and the measuring tube 12 are part of the process line.

The calibration system 20 has a calibration fastening device 23 with which the calibration tube 22 can be attached, in particular radially, to the measuring tube 12 or the process line and can be connected to the measuring tube 12 or the process line in a mechanically detachable manner. As a result, the carrier system 60 can also be at least indirectly connected in a mechanically detachable manner to the measurement system 10, in particular to the measuring tube 12.

In the embodiment shown, the exciter system 30 comprises a mechanical exciter that is in mechanical interaction with the measuring tube 12 if the calibration system 20 is mechanically connected to the measurement line 11, and continuously with the calibration tube 22 if the exciter system is permanently connected to the calibration tube 22. The sensor system 40 comprises at least one electrodynamic or optical sensor that is configured to detect a vibration of the measuring tube 12 and the calibration tube 22.

The embodiment shown is a clamp-on solution that can be arranged on existing process lines or hose systems and is configured not only to determine a process variable of the measuring medium flowing through the process line or hose system, but also to calibrate the measuring point.

FIG. 4 shows a third embodiment of the Coriolis flow-measuring device 1 according to the invention. In the embodiment shown, the measuring tube 12 and the calibration tube 22 are mechanically connected to each other, in particular in a non-detachable manner, via at least one mechanical coupler 71. The measuring tube 12 has at least one resonance frequency, which is equal to a resonance frequency of the calibration tube 22, in particular in such a way that a resonance frequency of a first-order bending oscillation mode inherent in the measuring tube 12 is equal to a resonance frequency of a first-order bending oscillation mode inherent in the calibration tube 22. Furthermore, the measuring tube 12 shown and the calibration tube 22 match with regard to one or more geometric parameters, in particular a (tube) length and/or a (tube) wall thickness and/or a caliber. In the embodiment shown, the measuring tube 12 and the calibration tube 22 are identical in construction.

The measuring tube 12 and the calibration tube 22 form a tube module that is designed as a disposable article. The tube module can be arranged on and detached from the carrier system 60 and/or the measurement line 11 and/or the calibration line in a mechanically detachable manner. In the arranged state, the tube module or the measuring tube 12 of the tube module is connected to the measurement line 11, via which the measuring medium to be monitored can be introduced into the measuring tube 12 and discharged. In the arranged state, the calibration tube 22 is further connected to a calibration line 21, via which the calibration medium can be introduced into the calibration tube 22 and discharged. The carrier system 60 comprises a carrier fastening device (not shown) via which the measuring tube 12 and/or the calibration tube 22 or the tube module can be connected to the carrier system 60 in a mechanically detachable manner. Suitable carrier fastening devices are disclosed in DE 102020114519 A1 and DE 102020127356A1 .

FIG. 5a shows a representation of the calibration process and FIG. 5b shows a representation of the measuring process of the Coriolis flow-measuring device. The method for calibrating and/or operating a Coriolis flow-measuring device 1 according to the invention comprises the following steps:

A calibration medium is carried through the calibration line 21. A suitable calibration medium contains water—in particular distilled water—glycerol or oil. However, the measuring tube 12 remains free of the measuring medium during calibration. Alternatively, a measuring medium, in particular a stationary one, can be present in the measuring tube 12 during calibration. If the calibration medium flows at a predetermined mass flow, a calibration is performed. The predetermined mass flow of the calibration medium can be set, for example, by means of a pump, in such a way that the mass flow of the calibration medium corresponds to a predetermined target mass flow and/or is equal to a mass flow of the measuring medium carried in the measurement line 11.

For calibration, the calibration tube 22 and the measuring tube 12 are made to perform oscillations by means of the exciter system 30. Furthermore, the oscillation of the calibration tube 22 and the measuring tube 12 is detected by means of a sensor system 40 in order to determine a calibration variable as a function of an overall system shown by the measurement system 10 and the calibration system 20. Once the (re-)calibration is completed, the predetermined mass flow of the calibration medium can be maintained or stopped. Alternatively, the calibration tube 22 may be free of the calibration medium during the determination of the mass flow, the medium density and/or the medium viscosity of the measuring medium.

Once the calibration variable has been determined, the measuring medium with a mass flow, medium density and/or medium viscosity to be monitored is carried through the measurement line 11 (see FIG. 5 b), and the calibration line 21 and the measurement line 11 are excited to oscillate by means of the exciter system 30. Since the calibration variable is known, the mass flow, the medium density and/or the medium viscosity of the measuring medium can be determined as a function of the detection signal determined via the sensor system 40 and the determined calibration variable.

The measuring medium and calibration medium are selected with regard to at least one substance parameter, in particular a density and/or a viscosity, such that they match, in particular match in such a way that the measuring medium is used as the calibration medium or the calibration medium corresponds to the measuring medium. This can be achieved, for example, via a bypass via which the measuring medium is carried from the process line into the calibration line and used there as the calibration medium.

Alternatively, the measuring medium and the calibration medium deviate from each other with regard to at least one substance parameter, in particular a density and/or a viscosity.

FIG. 6 shows a perspective view of a modular Coriolis flow-measuring device (see FIG. 4). The modular Coriolis flow-measuring device comprises a tube module M2 and a base module M1.

The base module M1 comprises a (protective) housing 111 with at least one chamber 111* at least partially encased by a housing wall 111+. The tube module M2 can be arranged in the chamber 111* in a mechanically fixed and yet mechanically detachable manner for forming a vibration-type measuring sensor or a vibronic measurement system and/or in such a way that the vibronic module M2 is locked in the base module M1 or is not movable.

Within the chamber 11* of the protective housing there is at least one placed electrical exciter coil 112, in particular one that is designed cylindrically and/or as an air coil, which exciter coil is at least indirectly mechanically connected to the housing wall 111+ and electrically connected to a measuring and calibration electronics ME. The embodiment shown has two exciter coils arranged opposite each other in the chamber 111*, which are configured to excite the tube module M2 to vibrate. Furthermore, at least two electrical sensor coils 114, 116, which are placed, in particular within the chamber 111* of the (protective) housing 111, in particular in each case cylindrical and/or designed as an air coil and/or identical in construction to the electrical exciter coil 112, are positioned, in particular remote from the first electrical coil and are at least indirectly mechanically connected to the housing wall 111+, which are electrically connected to the measuring and calibration electronics ME. The at least two sensor coils 114, 116 are configured to detect the vibration of the tube module M2. The embodiment shown has a total of four sensor coils, which are arranged in pairs on opposite sides of the housing wall 111+.

The tube module M2 comprises a measuring tube 131 for carrying the measuring medium and a calibration tube 132 for carrying the calibration medium. An exciter magnet 122 and two sensor magnets 124, 126 are positioned on an outer shell surface 131+of the measuring tube 131 in such a way that, in the arranged state of the tube module M2 in the base module M1, they are in interaction with the respectively assigned exciter coil or sensor coil. An exciter magnet and two sensor magnets (covered by the calibration tube) are also positioned on an outer shell surface 132+ of the calibration tube 132 in such a way that, in the arranged state of the tube module M2 in the base module M1, they are in interaction with the respectively assigned exciter coil or sensor coil (not shown). The tube module M2 shown, in particular the arrangement of the exciter magnets and sensor magnets, is mirror-symmetrical with respect to a longitudinal plane intersecting the tube module M2 and running between the measuring tube 131 and the calibration tube 132. The measuring and calibration electronics ME are configured to carry out method steps of the method according to the invention for calibrating and/or operating a Coriolis flow-measuring device.

1-29. (canceled)

30. A Coriolis flow-measuring device for determining a mass flow, a medium density and/or a medium viscosity of a fluid measuring medium in a process line, the flow-measuring device comprising:
a measurement system including a measurement line adapted to convey the measuring medium and at least one measuring tube, which is sterile and/or connected in a detachable manner to the measurement line and/or designed as a disposable product;
a calibration system including a calibration line separate from the measurement line and adapted to convey a calibration medium wherein the calibration system includes at least one calibration tube, which is non-sterile and/or is arranged parallel to the at least one measuring tube;
an exciter system configured to excite mechanical oscillations in both the measurement system and the calibration system;
a sensor system configured to detect mechanical oscillations of both the measurement system and the calibration system,
wherein the exciter system and the sensor system are each connected in a detachable manner to both the measurement system and the calibration system;
measuring and calibration electronics electrically connected to both the exciter system and the sensor system and configured to:
cause both the at least one measuring tube and the at least one calibration tube to oscillate via the exciter system,
determine oscillations of the at least one measuring tube and the at least one calibration tube via the sensor system,
determine at least one calibration variable of an overall system formed by the measurement system and the calibration system based on oscillations determined via the sensor system both of the measurement system conveying the measuring medium and of the calibration system conveying the calibration medium,
determine whether the calibration medium is conveyed in the calibration system with a predetermined reference mass flow and/or a predetermined reference density and/or a predetermined reference viscosity, and
based on the determined oscillations, both of the measurement system through which the measuring medium flows and of the calibration system conveying the calibration medium, determine the mass flow, the medium density and/or the medium viscosity of the measuring medium as a function of the at least one calibration variable and/or a variable derived therefrom, wherein the at least one calibration variable includes whether the measuring medium flows in the measurement system.

31. The Coriolis flow-measuring device according to claim 30, wherein the exciter system and the sensor system are in each case:
connected to the measurement system in a non-detachable manner and detachable again with the calibration system;
connected to the calibration system in a non-detachable manner and detachable again with the measurement system; or
connected to the calibration system in a detachable manner and detachable again with the measurement system.

32. The Coriolis flow-measuring device according to claim 30, wherein the measurement system and the calibration system are configured to be flowed through independently of each other by the measuring medium or calibration medium, respectively, such that the measuring medium and the calibration medium flow simultaneously with deviating mass flows and/or at different times through the Coriolis flow-measuring device.

33. The Coriolis flow-measuring device according to claim 30, wherein the calibration system includes a pump configured to pump the calibration medium through the calibration line with a predetermined or predeterminable mass flow such that a mass flow of the calibration medium is equal to the mass flow of the measuring medium and/or such that the mass flow of the calibration medium corresponds to a target mass flow determined based on oscillations determined via the sensor system of both the measurement system conveying the measuring medium and the calibration system conveying the calibration medium.

34. The Coriolis flow-measuring device according to claim 30, wherein the calibration system includes a calibration fastening device configured such that the at least one calibration tube is attachable to the at least one measuring tube for assembly in a mechanically detachable manner to the at least one measuring tube.

35. The Coriolis flow-measuring device according to claim 30, wherein the measurement system includes a measuring fastening device configured such that the at least one measuring tube is attachable to the at least one calibration tube for assembly in a mechanically detachable manner to the at least one calibration tube.

36. The Coriolis flow-measuring device according to claim 30, comprising:
a carrier system, wherein the exciter system and the sensor system are connected in a non-detachable manner to the carrier system.

37. The Coriolis flow-measuring device according to claim 36, wherein the at least one measuring tube and the at least one calibration tube are mechanically connected to each other in a non-detachable manner as to form a tube module,
wherein the tube module is configured to be arranged in a mechanically detachable manner on the carrier system.

38. The Coriolis flow-measuring device according to claim 36, wherein the carrier system includes a carrier fastening device configured to enable the at least one measuring tube and/or the at least one calibration tube to be connected to the carrier system in a mechanically detachable manner.

39. The Coriolis flow-measuring device according to claim 30, wherein the exciter system includes a mechanical exciter, which is in mechanical interaction with the at least one measuring tube and the at least one calibration tube.

40. The Coriolis flow-measuring device according to claim 30, wherein:
the exciter system includes an electromagnetic exciter, which is in magnetic interaction with a measuring tube magnet and a calibration tube magnet,
wherein the measuring tube magnet is disposed on the at least one measuring tube, and
wherein the calibration tube magnet is disposed on the at least one calibration tube.

41. The Coriolis flow-measuring device according to claim 30, wherein the sensor system includes at least one electrodynamic sensor, electromagnetic sensor, or optical sensor.

42. The Coriolis flow-measuring device according to claim 30, wherein the at least one measuring tube and the at least one calibration tube are mechanically coupled to each other by mechanical couplers.

43. The Coriolis flow-measuring device according to claim 30, wherein the at least one measuring tube has at least one resonance frequency, which is equal to a resonance frequency of the at least one calibration tube, such that a resonance frequency of a first-order bending oscillation mode inherent in the at least one measuring tube is equal to a resonance frequency of a first-order bending oscillation mode inherent in the at least one calibration tube, and/or
wherein the at least one measuring tube and the at least one calibration tube match with regard to one or more geometric parameters, including a tube length, a tube wall thickness, and/or a tube caliber.

44. The Coriolis flow-measuring device according to claim 30, wherein at least one of:
a tube wall of the at least one measuring tube consists of stainless steel;
a tube wall of the at least one calibration tube consists of a stainless steel;
the tube wall of the at least one calibration tube consists of a same material as the tube wall of the at least one measuring tube; and
the at least one measuring tube and the at least one calibration tube are identical in construction.

45. The Coriolis flow-measuring device according to claim 30, wherein the at least one measuring tube is part of the measurement line.

46. The Coriolis flow-measuring device according to claim 30, wherein the at least one calibration tube is an integral part of the calibration line.

47. The Coriolis flow-measuring device according to claim 30, wherein the calibration medium is different from the measuring medium, and/or the calibration medium is water or glycerol.

48. A method for calibrating and/or operating a Coriolis flow-measuring device, which comprises measuring and calibration electronics, a sensor system, an exciter system, a measurement system with a measurement line adapted for flowing a measuring medium therethrough and a calibration system with a calibration line, separate from the measurement line, adapted for flowing a calibration medium therethrough, the method comprising:
conducting the calibration medium through the calibration line,
performing a calibration when the calibration medium flows through the calibration line at a predetermined mass flow, wherein the calibration comprises:
using the exciter system, exciting the calibration line and the measurement line to perform oscillations;
using the sensor system, measuring the oscillations of a calibration tube of the calibration line and a measuring tube of the measurement line;
using the measuring and calibration electronics, determining at least one calibration variable as a function of the measured oscillations for an overall system provided by the measurement system and the calibration system;
flowing the measuring medium through the measurement line; and
determining a mass flow, a medium density, and/or a medium viscosity of the measuring medium as a function of the determined at least one calibration variable.

49. The method according to claim 48, wherein the measuring tube is free of the measuring medium during calibration.

50. The method according to claim 48, wherein the measuring tube contains a stationary measuring medium during calibration.

51. The method according to claim 48, wherein the calibration tube is free of the calibration medium during the determining of the mass flow, the medium density, and/or the medium viscosity of the measuring medium.

52. The method according to claim 48, wherein the calibration tube conveys a flowing calibration medium during the determining of the mass flow, the medium density, and/or the medium viscosity of the measuring medium.

53. The method according to claim 48, further comprising:
setting a mass flow of the calibration medium such that the mass flow of the calibration medium corresponds to a predetermined target mass flow and/or is equal to a mass flow of the measuring medium conveyed in the measurement line; and/or
using a pump, setting a mass flow of the calibration medium while the measurement line is conveying measuring medium and/or while no measuring medium is flowing in the measurement line.

54. The method according to claim 48, wherein the measuring medium and the calibration medium match with regard to at least one substance parameter such that the measuring medium is used as the calibration medium or the calibration medium corresponds to the measuring medium, wherein at least one substance parameter is a density and/or a viscosity.

55. The method according to claim 48, wherein the measuring medium and the calibration medium deviate from each other with regard to at least one substance parameter, wherein at least one substance parameter is a density and/or a viscosity.

56. The method according to claim 48, wherein at least one of:
the calibration medium contains water;
the calibration medium contains glycerol; and
the calibration medium contains oil or is an oil.

57. The method according to claim 48, further comprising:
exciting the calibration line and the measurement line to oscillate using the exciter system while the measurement line conveys the measuring medium flowing therethrough.

58. The method according to claim 48, wherein the calibration medium is different from the measuring medium.
